(19) United States
(12) Patent Application Publication
(10) Pub. No.: US 2021/0343995 A1
(43) Pub. Date: Nov. 4, 2021

(54) ELECTROCHEMICAL PLATING OF ADDITIVES ON METALLIC ELECTRODES FOR ENERGY DENSE BATTERIES

(71) Applicant: RESEARCH FOUNDATION OF THE CITY UNIVERSITY OF NEW YORK, New York, NY (US)

(72) Inventors: Gautam G. YADAV, New York, NY (US); Sanjoy BANERJEE, New York, NY (US)

(21) Appl. No.: 17/281,148

(22) PCT Filed: Oct. 3, 2019
(86) PCT No.: PCT/US2019/054516

§ 371 Date: Mar. 29, 2021

Related U.S. Application Data
(60) Provisional application No. 62/741,951, filed on Oct. 5, 2018.

(51) Int. Cl. H01M 4/04; H01M 4/38; H01M 4/48; C25D 3/54; H01M 4/26

(52) U.S. Cl. CPC H01M 4/0452; H01M 4/38; H01M 2004/027; C25D 3/54; H01M 4/26; H01M 4/48

(57) ABSTRACT

A metallic electrode comprises an electroactive material comprising zinc, aluminum, lithium, magnesium, silver, brass, copper, stainless steel, nickel, selenium, or any combination thereof, and an additive comprising a metal selected from the group consisting of bismuth, copper, indium, a salt thereof, an oxide thereof, and any combination thereof. The additive is plated in a layer on the electroactive material.

### CROSS-REFERENCE TO RELATED APPLICATIONS

This application claims the benefit of U.S. Provisional Application No. 62/741,951 filed on Oct. 5, 2018 and entitled “Electrochemical Plating of Additives on Metallic Electrodes for Energy Dense Batteries,” which is incorporated herein by reference in its entirety for all purposes.

### STATEMENT REGARDING GOVERNMENTALLY SPONSORED RESEARCH OR DEVELOPMENT

Not applicable.

### BACKGROUND

This disclosure relates to batteries including electrochemical cells. Alkaline manganese dioxide cells have been predominantly used as primary batteries. However, the one-time use of primary batteries results in large material wastage as well as undesirable environmental consequences. Also, potential economic losses can arise due to the significant imbalance between the energy that is required to manufacture these cells compared to the energy that can be actually stored. As a consequence, there is a clear advantage to provide rechargeable or secondary cells.

### SUMMARY

In some embodiments, a metallic electrode comprises an electroactive material comprising zinc, aluminum, lithium, magnesium, silver, brass, copper, stainless steel, nickel, selenium, or any combination thereof, and an additive comprising a metal selected from the group consisting of bismuth, copper, indium, a salt thereof, an oxide thereof, and any combination thereof. The additive is plated in a layer on the electroactive material.

In some embodiments, a method of electroplating comprises disposing an additive on a metallic electrode, pairing the metallic electrode with a counter electrode, placing the metallic electrode and counter electrode in an electrolyte, placing a reference electrode in contact with the electrolyte, using the reference electrode to determine a potential on the metallic electrode potential, applying the potential on the metallic electrode against the reference electrode, and reducing the additive to its metallic state in response to applying the potential. The additive comprises a metal selected from bismuth, copper, indium, a salt thereof, an oxide thereof, or any combination thereof.

In some embodiments, a battery comprises an anode, a cathode, an electrolyte, and a separator disposed between the anode and the cathode. The anode comprises an electroactive material and an additive. The electroactive material comprises zinc, aluminum, lithium, magnesium, silver, brass, copper, stainless steel, nickel, selenium, or any combination thereof, and the additive comprises a metal selected from bismuth, copper, indium, or a compound of the metal. The additive is plated in a layer on the electroactive material.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 schematically illustrates a battery according to an embodiment.

FIG. 2 illustrates the capacity retention of Zn mesh coated with bismuth oxide in an alkaline electrolyte according to the process of Example 1.

FIG. 3 illustrates the capacity retention of Zn mesh coated with bismuth oxide in alkaline electrolyte according to the process of Example 2.

FIG. 4 illustrates the capacity retention of Zn mesh coated with bismuth oxide in alkaline electrolyte according to the process of Example 3.

FIG. 5 illustrates the capacity retention of Zn mesh coated with indium oxide in alkaline electrolyte according to the process of Example 4.

### DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

Metallic electrodes like zinc, aluminum, lithium, magnesium, selenium, etc. are widely used as anodes in a range of battery chemistries. Zinc (Zn) anodes are typically used in aqueous-based chemistries because of its low cost, non-flammable nature and wide availability. Most importantly, it has a low standard reduction potential and high theoretical capacity of 820 mAh/g, which can be used for energy dense applications. Unfortunately in acidic or alkaline electrolyte, zinc has a tendency to corrode and lose its capacity and activity. As disclosed herein, the incorporation of additives that plate on the surface of the metallic electroactive materials (e.g., metallic Zn surfaces) can be used to prevent the corrosion of the electroactive materials and provide access to a high fraction of the theoretical capacity (50-100%). This surface layer formation can be termed as “solid electrolyte interface (SEI)” as it protects the electroactive material from the electrolyte. This method can be applied for metallic electrodes other than Zn to improve performance and stability as well.

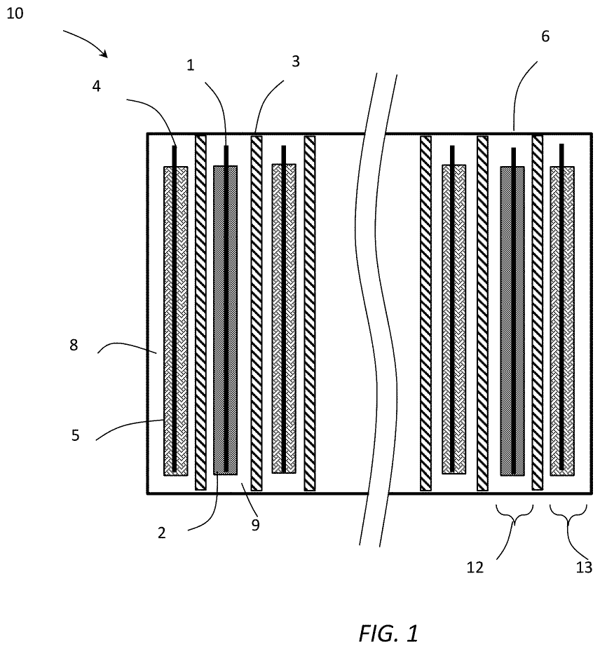

Disclosed herein are methods for forming electrodes having an SEI disposed on or plated onto an electroactive materials. The resulting electrodes can then be used to form batteries for use as primary or secondary batteries. Referring to FIG. 1, a battery 10 has a housing 6, a cathode current collector 1, a cathode material 2, a separator 3, an anode current collector 4, and an anode material 5. FIG. 1 shows a prismatic battery arrangement. In another embodiment, the battery can be a cylindrical having the electrodes arranged concentrically or in a rolled configuration in which the anode and cathode are layered and then rolled to form a jellyroll configuration. An electrolyte can be dispersed in an open space throughout battery 10. In some embodiments, the electrolyte in contact with each type of electrode can have a different composition specific to each electrode. For example, an anolyte can be in contact with the anode and a catholyte can be in contact with the cathode. For example, an anolyte 8 can be dispersed around the anode 5 and contained by the separator 3. Similarly a catholyte 9 can be dispersed around the cathode material 2 and contained by the separator 3, thereby preventing the anolyte 8 and the catholyte 9 from mixing. The cathode current collector 1 and cathode material 2 are collectively called either the cathode 12 or the positive electrode 12. Similarly, the anode current collector 4 and the anode material 5 are collectively called either the anode 13 or the negative electrode 13.

As shown in FIG. 1, the battery 10 can comprise one or more cathodes 12 and one or more anodes 13. When a plurality of anodes 13 and/or cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage.

The cathode 12 can comprise a mixture of components including an electrochemically active material, a binder, a conductive material, and one or more additional components that can serve to improve the lifespan, rechargeability, and electrochemical properties of the cathode 12. The cathode 12 can be incorporated into the battery 10. The cathode can comprise an active cathode material (e.g., an electroactive material). Suitable materials can include, but are not limited to, manganese dioxide, copper manganese oxide, hausmannite, manganese oxide, copper intercalated bismuth birnessite, birnessite, todokorite, ramsdellite, pyrolusite, pyrochroite, nickel hydroxide, sintered nickel, nickel oxyhydroxide, potassium permanganate, cobalt oxide, silver oxide, silver, lithium manganese oxide, lithium manganese nickel cobalt oxide, lithium iron phosphate, copper oxide, manganese oxide, lithium vanadium phosphate, vanadium phosphate, vanadium pentoxide, nickel, copper, copper hydroxide, lead, lead hydroxide, lead oxide, or a combination thereof

In some embodiments, the active cathode material can based on one or many polymorphs of MnO₂, including electrolytic (EMD), α-MnO₂, β-MnO₂, γ-MnO₂, δ-MnO₂, ε-MnO₂, or λ-MnO₂. Other forms of MnO₂ can also be present such as pyrolusite, ramsdellite, nsutite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide, zinc manganese dioxide. In general the cycled form of manganese dioxide in the cathode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

The addition of a conductive additive such as conductive carbon enables high loadings of an electroactive material in the cathode material, resulting in high volumetric and gravimetric energy density. The conductive carbon can be present in a concentration between about 1-30 wt %. Such conductive carbon include single walled carbon nanotubes, multi-walled carbon nanotubes, graphene, carbon blacks of various surface areas, and others that have specifically very high surface area and conductivity. Higher loadings of the electroactive material in the cathode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades(examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), carbon nanotubes plated with metal like nickel and/or copper, graphene, graphyne, graphene oxide, Zenyatta graphite, and combinations thereof. When the electroactive material comprises manganese, the birnessite discharge reaction comprises a dissolution-precipitation reaction where Mn³⁺ ions become soluble and precipitate out on the conductive carbon as Mn²⁺. This second electron process involves the formation of a non-conductive manganese hydroxide [Mn(OH)₂] layer on the conductive graphite.

The conductive additive can have a particle size range from about 1 to about 50 microns, or between about 2 and about 30 microns, or between about 5 and about 15 microns. In an embodiment, the conductive additive can include expanded graphite having a particle size range from about 10 to about 50 microns, or from about 20 to about 30 microns. In some embodiments, the mass ratio of graphite to the conductive additive can range from about 5:1 to about 50:1, or from about 7:1 to about 28:1. The total carbon mass percentage in the cathode paste can range from about 5% to about 30% or between about 10% to about 20%.

The addition of a conductive component such as metal additives to the cathode material may be accomplished by addition of one or more metal powders such as nickel powder to the cathode mixture. The conductive metal component can be present in a concentration of between about 0-30 wt %. The conductive metal component may be, for example, nickel, copper, silver, gold, tin, cobalt, antimony, brass, bronze, aluminum, calcium, iron or platinum. In one embodiment, the conductive metal component is a powder. In one embodiment, a second conductive metal component is added to act as a supportive conductive backbone for the first and second electron reactions to take place. The second electron reaction has a dissolution-precipitation reaction where Mn³⁺ ions become soluble in the electrolyte and precipitate out on the graphite resulting in an electrochemical reaction and the formation of manganese hydroxide [Mn(OH)₂] which is non-conductive. This ultimately results in a capacity fade in subsequent cycles. Suitable second component include transition metals like Ni, Co, Fe, Ti and metals like Ag, Au, Al, Ca. Salts or such metals are also suitable. Transition metals like Co also help in reducing the solubility of Mn³⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% second conductive metal component and 1-10% binder.

In some embodiments a binder can be used. The binder can be present in a concentration of between about 0-10 wt %. In some embodiments, the binder comprises water-soluble cellulose-based hydrogels, which were used as thickeners and strong binders, and have been cross-linked with good mechanical strength and with conductive polymers. The binder may also be a cellulose film sold as cellophane. The binders were made by physically cross-linking the water-soluble cellulose-based hydrogels with a polymer through repeated cooling and thawing cycles. In one embodiment, 0-10 wt. % carboxymethyl cellulose (CMC) solution was cross-linked with 0-10 wt. % polyvinyl alcohol (PVA) on an equal volume basis. The binder, compared to the traditionally-used TEFLON®, shows superior performance. TEFLON® is a very resistive material, but its use in the industry has been widespread due to its good rollable properties. This, however, does not rule out using TEFLON® as a binder. Mixtures of TEFLON® with the aqueous binder and some conductive carbon were used to create rollable binders. Using the aqueous-based binder helps in achieving a significant fraction of the two electron capacity with minimal capacity loss over many cycles. In one embodiment, the binder is water-based, has superior water retention capabilities, adhesion properties, and helps to maintain the conductivity relative to an identical cathode using a TEFLON® binder instead. Examples of hydrogels include methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC). Examples of crosslinking polymers include polyvinyl alcohol, polyvinylacetate, polyaniline, polyvinylpyrrolidone, polyvinylidene fluoride and polypyrrole. In one such embodiment, a 0-10 wt % solution of water-cased cellulose hydrogen is cross linked with a 0-10% wt solution of crosslinking polymers by, for example, repeated freeze/thaw cycles, radiation treatment or chemical agents (e.g. epichlorohydrin). The aqueous binder may be mixed with 0-5% TEFLON® to improve manufacturability.

Additional elements can be included in the cathode material including a bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long term performance with the copper and bismuth incorporated into the crystal and nanostructure of the birnessite.

The bismuth compound can be incorporated into the cathode 12 as an inorganic or organic salt of bismuth (oxidation states 5, 4, 3, 2, or 1), as a bismuth oxide, or as bismuth metal (i.e. elemental bismuth). The bismuth compound can be present in the cathode material at a concentration between about 1-20 wt %. Examples of inorganic bismuth compounds include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, triphenylbismuth.

The copper compound can be incorporated into the cathode 12 as an organic or inorganic salt of copper (oxidation states 1, 2, 3, or 4), as a copper oxide, or as copper metal (i.e., elemental copper). The copper compound can be present in a concentration between about 1-70 wt %. In one embodiment, the copper compound is present in a concentration between about 5-50 wt %. In another embodiment, the copper compound is present in a concentration between about 10-50 wt %. In yet another embodiment, the copper compound is present in a concentration between about 5-20 wt %. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper is to alter the oxidation and reduction voltages of bismuth. This results in a cathode with full reversibility during galvanostatic cycling, as compared to a bismuth-modified MnO₂ which will not withstand galvanostatic cycling.

The cathodes 12 can be produced using methods implementable in large-scale manufacturing. For a MnO₂ cathode, the cathode 12 can be capable of delivering the full second electron capacity of 617 mAh/g of the MnO₂. Excellent rechargeable performance can be achieved for both low and high loadings of MnO₂ in the mixed material, allowing the cell/battery to achieve very high practical energy densities. In some embodiments, the cathode material can comprises 2-30% wt conductive carbon, 0-30% conductive metal additive, 1-70% wt. copper compound, 1-20% wt bismuth compound, 0-10% wt binder and birnessite or EMD. In another embodiment the cathode material comprises 2-30% wt conductive carbon, 0-30% conductive metal additive, 1-20% wt bismuth compound, 0-10% wt binder and birnessite or EMD. In one embodiment, the cathode material consists essentially of 2-30% wt conductive carbon, 0-30% conductive metal additive, 1-70% wt. copper compound, 1-20% wt bismuth compound, 0-10% wt binder and the balance birnessite or EMD. In another embodiment the cathode material consists essentially of 2-30% wt conductive carbon, 0-30% conductive metal additive, 1-20% wt bismuth compound, 0-10% wt binder and the balance birnessite or EMD.

The resulting cathode may have a porosity in the range of 20%-85% as determined by mercury infiltration porosimetry. In one embodiment, the porosity is measured according to ASTM D4284-12 “Standard Test Method for Determining Pore Volume Distribution of Catalysts and Catalyst Carriers by Mercury Intrusion Porosimetry.”

The cathode material 2 can be formed on a cathode current collector 1 formed from a conductive material that serves as an electrical connection between the cathode material and an external electrical connection or connections. In some embodiments, the cathode current collector 1 can be, for example, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, half nickel and half copper, or any combination thereof. The cathode current collector may be formed into a mesh (e.g., an expanded mesh, woven mesh, etc.), perforated metal, foam, foil, perforated foil, wire screen, a wrapped assembly, or any combination thereof. In some embodiments, the current collector can be formed into or form a part of a pocket assembly. A tab (e.g., a portion of the cathode current collector 1 extending outside of the cathode material 2 as shown at the top of the cathode 12 in FIG. 1A) can be coupled to the current collector to provide an electrical connection between an external source and the current collector.

The battery 10 can also comprise an anode 13 having an anode material 5 in electrical contact with an anode current collector 4. In some embodiments, the anode can be coated with an SEI as described in more detail herein. In some embodiments, the anode material (e.g., the electroactive component) can comprise zinc, aluminum, lithium, magnesium, selenium, or any combination thereof. In some embodiments, the anode material 5 can comprise zinc, which can be present as elemental zinc and/or zine oxide. In some embodiments, the Zn anode mixture comprises Zn, zinc oxide (ZnO), an electronically conductive material, and a binder. The Zn may be present in the anode material 5 in an amount of from about 50 wt. % to about 90 wt. %, alternatively from about 60 wt. % to about 80 wt. %, or alternatively from about 65 wt. % to about 75 wt. %, based on the total weight of the anode material. In an embodiment, Zn may be present in an amount of about 85 wt. %, based on the total weight of the anode material. Additional elements that can be in the anode in addition to the zinc or in place of the zinc include, but are not limited to, lithium, aluminum, magnesium, iron, cadmium and a combination thereof

In some embodiments, ZnO may be present in an amount of from about 5 wt. % to about 20 wt. %, alternatively from about 5 wt. % to about 15 wt. %, or alternatively from about 5 wt. % to about 10 wt. %, based on the total weight of anode material. In an embodiment, ZnO may be present in anode material in an amount of about 10 wt. %, based on the total weight of the anode material. As will be appreciated by one of skill in the art, and with the help of this disclosure, the purpose of the ZnO in the anode mixture is to provide a source of Zn during the recharging steps, and the zinc present can be converted between zinc and zinc oxide during charging and discharging phases.

In an embodiment, an electrically conductive material may be present in the anode material in an amount of from about 5 wt. % to about 20 wt. %, alternatively from about 5 wt. % to about 15 wt. %, or alternatively from about 5 wt. % to about 10 wt. %, based on the total weight of the anode material. In an embodiment, the electrically conductive material may be present in anode material in an amount of about 10 wt. %, based on the total weight of the anode material. As will be appreciated by one of skill in the art, and with the help of this disclosure, the electrically conductive material is used in the Zn anode mixture as a conducting agent, e.g., to enhance the overall electric conductivity of the Zn anode mixture. Nonlimiting examples of electrically conductive material suitable for use in this disclosure include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive material can also comprise any of the conductive carbon materials described with respect to the cathode material including, but not limited to, acetylene black, single walled carbon nanotubes, multi-walled carbon nanotubes, graphene, graphyne, or any combinations thereof.

The anode material may also comprise a binder. Generally, a binder functions to hold the electroactive material particles (e.g., Zn used in anode, etc.) together and in contact with the current collector. The binder is present in a concentration of 0-10 wt %. The binders may comprise water-soluble cellulose-based hydrogels like methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC), which were used as thickeners and strong binders, and have been cross-linked with good mechanical strength and with conductive polymers like polyvinyl alcohol, polyvinylacetate, polyaniline, polyvinylpyrrolidone, polyvinylidene fluoride and polypyrrole. The binder may also be a cellulose film sold as cellophane. The binder may also be TEFLON®, which is a very resistive material, but its use in the industry has been widespread due to its good rollable properties.

In some embodiments, the binder may be present in anode material in an amount of from about 2 wt. % to about 10 wt. %, alternatively from about 2 wt. % to about 7 wt. %, or alternatively from about 4 wt. % to about 6 wt. %, based on the total weight of the anode material. In an embodiment, the binder may be present in anode material in an amount of about 5 wt. %, based on the total weight of the anode material.

A current collector 4 can be used with an anode 13, including any of those described with respect to the cathode 12. The anode material 5 can be pressed onto the anode current collector 4 to form the anode 13. For example, the anode and/or the cathode materials can be adhered to a corresponding current collector by pressing at, for example, a pressure between 1,000 psi and 20,000 psi (between 6.9×10⁶ and 1.4×10⁸ Pascals). The cathode and anode materials may be adhered to the current collector as a paste. A tab of each current collector, when present, can extend outside of the device to form the current collector tab.

In some embodiments, a separator can be disposed between the anode 13 and the cathode 12 when the electrodes are constructed into the battery. The separator 3 may comprise one or more layers. Suitable layers can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X100™ or oxygen plasma treatment. In some embodiments, the separator 3 can comprise a CELGARD® brand microporous separator. In an embodiment, the separator 3 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, or a combination thereof.

Within the battery, an electrolyte can be present between the anode and the cathode. In some embodiments, the electrolyte can comprise an alkaline electrolyte (e.g. an alkaline hydroxide, such as NaOH, KOH, LiOH, ammonium hydroxide, or mixtures thereof). In some embodiments, the electrolyte can comprise an acidic solution, alkaline solution, ionic liquid, organic-based, solid-phase, gelled, etc. or combinations thereof that conducts lithium, magnesium, aluminum and zinc ions. Examples include chlorides, sulfates, sodium hydroxide, potassium hydroxide, lithium hydroxide, ammonium hydroxide, perchlorates like lithium perchlorate, magnesium perchlorate, aluminum perchlorate, lithium hexafluorophosphate, [M⁺[]AlCl⁴⁻](M⁺)]-sulphonyl chloride or phosphoryl chloride cations, 1-ethyl-3-methylimidazolium bis (trifluoromethylsulfonyl)imide, 1-ethyl-3-methylimidazolium trifluoromethanesulfonate, 1-butly-1-methylpyrrolidinium bis(trifluoromethyl sulfonyl)imide,1-hexyl-3-methylimidazolium hexofluorophosphate,1-ethyl-3-methylimidazolium dicyanamide,11-methyl-3 -octylimidazolium tetrafluoroborate, yttria-stabilized zirconia, beta-alumina solid, polyacrylamides, NASICON, lithium salts in mixed organic solvents like 1,2-dimethoxyethane, propylene carbonate, magnesium bis(hexamethyldisilazide) in tetrahydrofuran and a combination thereof. In some embodiments, the electrolyte can comprise manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or a combination thereof. The pH of the electrolyte can vary from 0-15.

In order to help prevent the corrosion of the electrode material once the battery is assembled, an SEI can be formed on the electroactive material. The SEI can be formed on the material of the cathode and/or anode, depending on the materials used to form the electrode. The SEI can be formed by disposing an SEI pre-cursor material in contact with the electroactive material and cycling the cell to reduce the SEI material to its elemental state. The SEI material can then serve to protect the electroactive material within the battery. The use of the SEI material can then improve the overall performance and longevity of a battery constructed with the electrode.

The SEI can be used to protect the electroactive material (e.g., the component(s) responsible for electrochemical reactions to generate current during discharge and react to store energy during charging of the electrode). In some embodiments, the electroactive material can comprise zinc, aluminum, lithium, magnesium, silver, brass, copper, stainless steel, nickel, selenium, or any combination thereof. The electrode can be formed as described above with respect to the anode and/or cathode with regard to the presence of a current collector and one or more additives used to form the electrodes. The electroactive material can be present in the electrode in any suitable form. In some embodiments, the electroactive material can be a powder, a metallic foil, a mesh, a perforated foil, a patterned foil, a patterned mesh, wire cloth, woven wire, wire mesh, expanded metal, twisted metal, wire, metallic screen, hexagonal netting, or any combination thereof.

In order to form the SEI, an additive can be disposed on the electrode. The additive can be selected to allow for a solid layer to form on the electroactive material to provide an interface between the electroactive material and the electrolyte when assembled into a battery. In some embodiments, the SEI can be more resistant to corrosion and reactions within the electrolyte than the electroactive material. In some embodiments, the additive used to form the SEI can comprise bismuth, copper, indium, oxides thereof, salts thereof (e.g., hydroxides, sulfides, tellurides, selenides, nitrates, chlorides, etc.), or any combination thereof. In some embodiments, the additive can comprise bismuth oxide, bismuth, bismuth hydroxide, bismuth sulfide, bismuth telluride, bismuth selenide, bismuth nitrate, bismuth chloride, copper oxide, copper, copper hydroxide, copper chloride, copper nitrate, indium oxide, indium hydroxide, indium nitrate, or any combination thereof.

Depending on the form of the additive, the SEI can be formed on the electroactive material using an electroplating process. In this process, the additive can be disposed on the electrode containing the electroactive material. In some embodiments, the additive can be placed directly on the electroactive material in the electrode. For example, the additive can be formed into a paste and pasted on the electrode and/or electroactive material. Once formed, the electrode with the additive can then be cycled to reduce the additive to a form suitable to form the SEI. In some embodiments, the electrode can comprise one or more layers of separator material.

In some embodiments, the electrode having the additive disposed thereon can be paired against a counter electrode, and both the electrode and the counter electrode can be placed in contact with an electrolyte. For example, the two electrode system can be immersed in an electrolyte. The electrolyte used for the electroplating process can be any suitable electrolyte, including those described herein for use in a battery. In some embodiments, the electroplating electrolyte can comprise manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or any combination thereof.

The counter electrode can be any suitable electrode including any of the anodes and/or cathodes as described herein that are suitable as a counter electrode to the corresponding material in the electrode being formed. In some embodiments, the counter electrode can comprise nickel oxyhydroxide, manganese dioxide, silver oxide, silver, copper, copper oxide, lithium manganese dioxide, lead, platinum, or any combination thereof.

A reference electrode can be optionally used in contact with the electrolyte to allow the potential and current between the electrode and the counter-electrode to be monitored during the electroplating process. Any suitable reference electrode can be used to allow the potentials to be measured. In some embodiments, the reference electrode can be a mercury/mercury oxide (Hg|HgO) reference electrode.

A potential can then be applied on the electrode at a predetermined potential to reduce the additive to its metallic state, and thereby form the SEI on the electroactive material. The potential and/or current can be applied and monitored using the reference electrode. The application of the current to the electrode (e.g., between the counter-electrode and the electrode) can use a constant potential, a constant voltage, a constant current, a constant load, a pulse current, a potentiodynamic application of current/potential, or any combination thereof.

The electrode can be cycled to form the SEI. The initial cycling can serve to convert the material of the additive to a metallic form. For example, when bismuth oxide is used in the additive, the initial cycling can serve to convert the bismuth oxide to bismuth metal, which can then serve as the SEI between the electroactive material and the electrolyte. In some embodiments, the potential ranges for electroplating in an electrolyte comprising potassium hydroxide, sodium hydroxide, and/or lithium hydroxide against a Hg|HgO reference electrode can be between about −2 V and about 0.4 V. For example, the potential ranges for electroplating in an electrolyte comprising potassium hydroxide, sodium hydroxide, and/or lithium hydroxide against a Hg|HgO reference electrode can be between −2 and −1V, between −2V to 0V, between −2V and 0.4V, or between −1.5V and −1V. The cycling can result in the plating of the SEI on the electroactive material in the electrode.

The resulting electrodes having the SEI can demonstrate good cycling and stability within a battery. In some embodiments, the resulting electrodes having the SEI can have an areal capacity of between about 4 mAh/cm² and about 140 mAh/cm², or between about 20 mAh/cm² and about 120 mAh/cm², or up to about 110 mAh/cm².

The resulting electrode can then be cycled within the electrolyte or removed and used in a battery. The electroplating process can allow for a plurality of electrodes to be formed with the SEI as a batch. Once the SEI is formed, the electrodes can be removed from the electrolyte and used to form one or more batteries, as described herein. Once constructed, any of the batteries as described herein can be cycled during use by being charged and discharged.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

To demonstrate the effectiveness of the electrochemical coating, a control cell was made where only a metallic zinc (Zn) mesh was used as the electrode. This Zn mesh was paired against a nickel oxyhydroxide counter electrode and cycled with reference mercury|mercury oxide (Hg|HgO). The Zn mesh was welded on a copper mesh, where the copper provided backing to the Zn mesh. This Zn mesh was cycled between −1.65 and −1V vs Hg|HgO in 45 wt. % potassium hydroxide (KOH) at C/20. The Zn mesh was wrapped in cellophane as the separator.

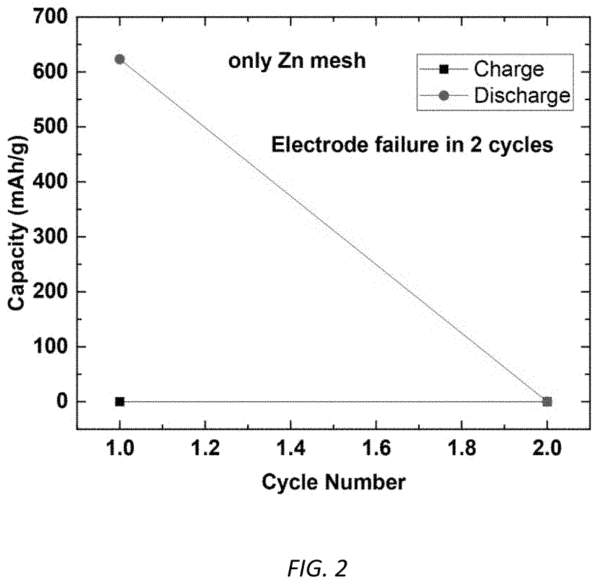

The cycling results of the Zn mesh is shown in FIG. 2. The Zn mesh was able to discharge in its first cycle to around 623 mAh/g, which is close to its theoretical capacity of 820 mAh/g. However, after the first discharge the Zn mesh failed catastrophically as it wasn't able to charge or discharge after the first cycle.

### Example 2

After the early failure of the control cell, the electrochemical plating procedure was used to cover the Zn mesh with metallic additives. The Zn mesh was pasted with bismuth oxide only. This bismuth oxide was pressed onto the Zn mesh to form a structurally robust electrode. The Zn mesh with bismuth oxide coating was paired against a nickel oxyhydroxide counter electrode and cycled with reference mercury|mercury oxide (Hg|HgO). The Zn mesh with the bismuth oxide coating had a copper mesh backing as well. This coated electrode was cycled between −1.65V and −1V Hg|HgO in 45 wt. % potassium hydroxide (KOH) with zinc oxide dissolved at C/20. The coated Zn mesh was wrapped in cellophane as the separator.

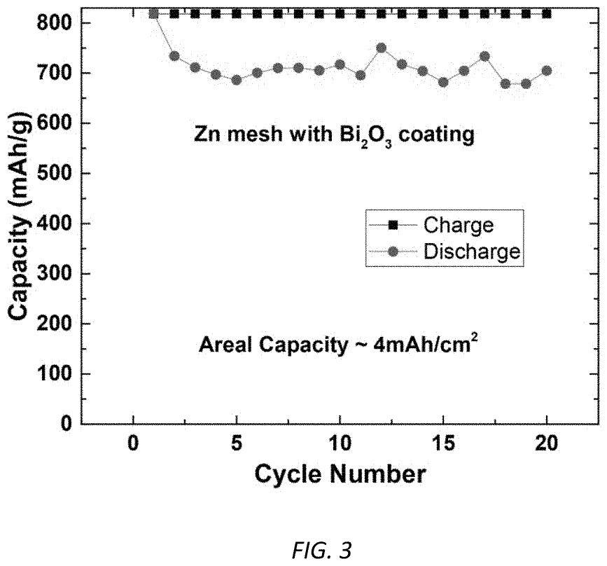

The starting OCV of the cell was around −0.26V vs Hg|HgO, which was due to bismuth oxide making the Zn mesh potential very positive. After applying constant current the cell potential immediately went to −1.28V and then increased further against Hg|HgO. The sudden jump in potential meant that bismuth oxide had completely converted to bismuth metal as ˜−1V vs Hg|HgO bismuth oxide is known to reduce to metallic bismuth. The further increase in potential meant that the electrode entered into Zn plating and deplating region of −1.65V and −1V vs Hg|HgO, where the cell was cycled. The constant cycling of the cell in the −1.65V and −1V vs Hg|HgO resulted in stable cycling and high capacity utilizations as shown in FIG. 3. The areal capacity of the Zn anode was also high at ˜4 mAh/cm².

### Example 3

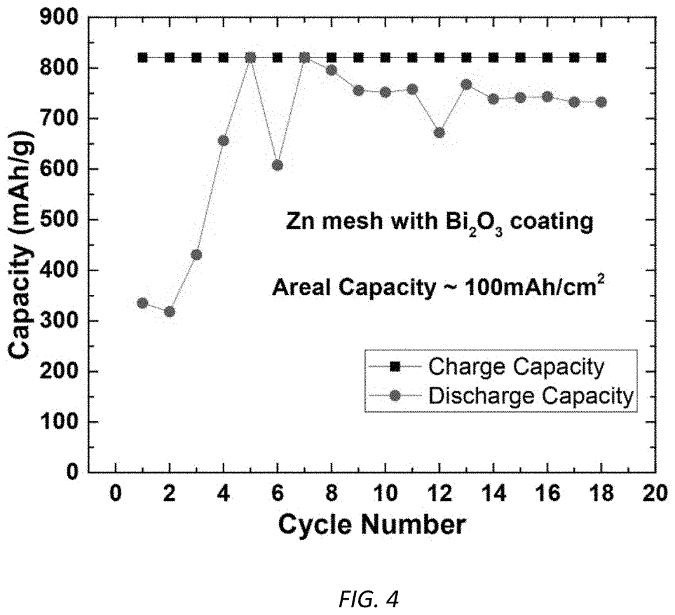

The cell in Example 3 was an exact replica of the cell in Example 2, except the areal capacity of the bismuth oxide coated Zn anode was increased to 100 mAh/cm² to test its applicability in real life applications. The cell started exactly the same way as reported in example 2, where the OCV was around −0.2V vs Hg|HgO. The onset of current resulted in converting bismuth oxide to metallic bismuth at ˜−1V vs Hg|HgO, after which the Zn mesh was covered by a layer of metallic bismuth. This metallic layer acted as the solid electrolyte interface that prevented further corrosion of Zn metal. The cycle life of this electrode is shown in FIG. 4, where the capacity utilization is high and the cycling stability at ˜100 mAh/cm² is very robust.

### Example 4

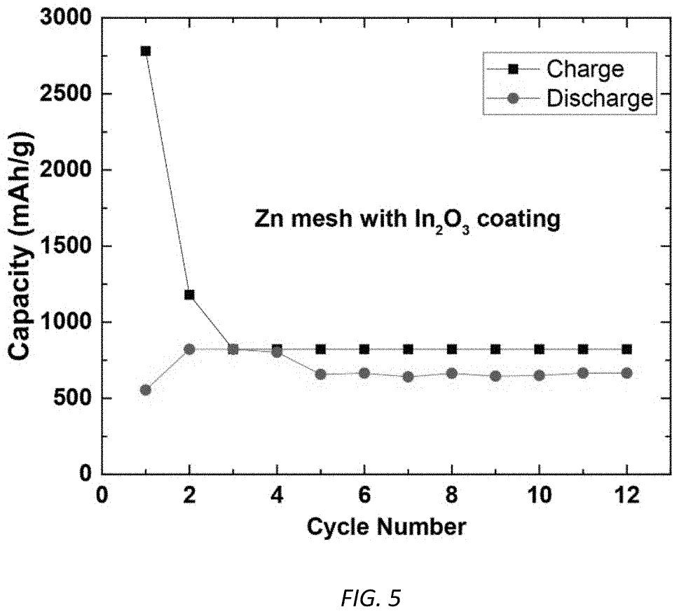

The cell in Example 4 was again an exact replica of the cell in Example 3, except the Zn anode mesh was pasted with indium oxide. Similarly to bismuth oxide, indium oxide also reduces to metallic indium at lower potentials of Hg|HgO. The OCV of the cell was also ˜−0.22V vs Hg|HgO in the case of indium oxide coating. The application of a reducing current resulted in converting indium oxide to metallic indium on the Zn mesh, which acted as a protective barrier or solid electrolyte interface. The stable cycling results of the indium oxide coated Zn mesh is shown in FIG. 5, where the Zn mesh is able to retain very high capacity utilizations.

Having described various electrodes, processes, and devices, specific embodiments can include, but are not limited to:

In a first embodiment, a metallic electrode comprises: an electroactive material comprising zinc, aluminum, lithium, magnesium, silver, brass, copper, stainless steel, nickel, selenium, or any combination thereof; and an additive comprising a metal selected from the group consisting of bismuth, copper, indium, a salt thereof, an oxide thereof, and any combination thereof, wherein the additive is plated in a layer on the electroactive material.

A second embodiment can include the metallic electrode of the first embodiment, where the electroactive material is in the form of a powder, a metallic foil, a mesh, a perforated foil, a patterned foil, a patterned mesh, a wire cloth, a woven wire, a wire mesh, an expanded metal, a twisted metal, a wire, a metallic screen, a hexagonal netting, or any combination thereof.

A third embodiment can include the metallic electrode of the first or second embodiment, where the additive is bismuth oxide, bismuth, bismuth hydroxide, bismuth sulfide, bismuth telluride, bismuth selenide, bismuth nitrate, bismuth chloride, copper oxide, copper, copper hydroxide, copper chloride, copper nitrate, indium oxide, indium hydroxide, indium nitrate, or any combination thereof.

A fourth embodiment can include the metallic electrode of any one of the first to third embodiments, wherein the electroactive material comprises zinc.

In a fifth embodiment, a method of electroplating comprises: disposing an additive on a metallic electrode, wherein the additive comprises a metal selected from bismuth, copper, indium, a salt thereof, an oxide thereof, or any combination thereof pairing the metallic electrode with a counter electrode; placing the metallic electrode and counter electrode in an electrolyte; placing a reference electrode in contact with the electrolyte; using the reference electrode to determine a potential on the metallic electrode potential; applying the potential on the metallic electrode against the reference electrode; and reducing the additive to its metallic state in response to applying the potential.

A sixth embodiment can include the method of the fifth embodiment, wherein disposing the additive on the metallic electrode comprises: forming a paste from the additive; and pasting the paste onto the metallic electrode.

A seventh embodiment can include the method of the fifth or sixth embodiment, wherein the additive in its metallic state is plated in a layer on an electroactive material of the metallic electrode.

An eighth embodiment can include the method of any one of the fifth to seventh embodiments, wherein the additive is bismuth oxide, bismuth, bismuth hydroxide, bismuth sulfide, bismuth telluride, bismuth selenide, bismuth nitrate, bismuth chloride, copper oxide, copper, copper hydroxide, copper chloride, copper nitrate, indium oxide, indium hydroxide, indium nitrate, or any combination thereof.

A ninth embodiment can include the method of any one of the fifth to eighth embodiments, wherein the counter electrode is nickel oxyhydroxide, manganese dioxide, silver oxide, silver, copper, copper oxide, lithium manganese dioxide, lead, platinum, or any combination thereof.

A tenth embodiment can include the method of any one of the fifth to ninth embodiments, wherein the electrolyte is manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or any combination thereof.

An eleventh embodiment can include the method of any one of the fifth to tenth embodiments, wherein the reference electrode is mercury/mercury oxide (Hg|HgO).

A twelfth embodiment can include the method of any one of the fifth to eleventh embodiments, wherein the step of applying potential on the metallic electrode is constant voltage, constant current, constant load, pulse current, potentiodynamic, or any combination thereof.

A thirteenth embodiment can include the method of any one of the fifth to twelfth embodiments, wherein the potential ranges for electroplating in potassium hydroxide, sodium hydroxide and lithium hydroxide against a Hg|HgO is between −2 and −1V.

A fourteenth embodiment can include the method of any one of the fifth to twelfth embodiments, wherein electrolyte is selected from a group consisting of potassium hydroxide, sodium hydroxide and lithium hydroxide and a potential between −2V to 0V against a Hg|HgO electrode is applied.

A fifteenth embodiment can include the method of any one of the fifth to twelfth embodiments, wherein the electrolyte is selected from a group consisting of potassium hydroxide, sodium hydroxide and lithium hydroxide and a potential between −2V and 0.4V against a Hg|HgO electrode is applied to electroplate.

A sixteenth embodiment can include the method of any one of the fifth to twelfth embodiments, wherein the electrolyte is selected from a group consisting of potassium hydroxide, sodium hydroxide and lithium hydroxide and a poatential between −1.5V and −1V against a Hg|HgO electrode is applied.

In a seventeenth embodiment, a battery comprises: an anode, wherein the anode comprises an electroactive material and an additive, wherein the electroactive material comprises zinc, aluminum, lithium, magnesium, silver, brass, copper, stainless steel, nickel, selenium, or any combination thereof, wherein the additive comprises a metal selected from bismuth, copper, indium, or a compound of the metal, and wherein the additive is plated in a layer on the electroactive material; a cathode; an electrolyte; and a separator disposed between the anode and the cathode.

An eighteenth embodiment can include the battery of the seventeenth embodiment, wherein the cathode is manganese dioxide, copper manganese oxide, hausmannite, manganese oxide, copper intercalated bismuth birnessite, birnessite, todokorite, ramsdellite, pyrolusite, pyrochroite, nickel hydroxide, sintered nickel, nickel oxyhydroxide, potassium permanganate, cobalt oxide, silver oxide, silver, lithium manganese oxide, lithium manganese nickel cobalt oxide, lithium iron phosphate, copper oxide, manganese oxide, lithium vanadium phosphate, vanadium phosphate, vanadium pentoxide, or any combination thereof.

A nineteenth embodiment can include the battery of the seventeenth or eighteenth embodiment, wherein the electrolyte is manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or any combination thereof.

A twentieth embodiment can include the battery of any one of the seventeenth to twentieth embodiments, wherein the separator is lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, CELGARD®, cellophane, or any combination thereof.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

What is claimed is:

1. A metallic electrode comprising:
an electroactive material comprising zinc, aluminum, lithium, magnesium, silver, brass, copper, stainless steel, nickel, selenium, or any combination thereof; and
an additive comprising a metal selected from the group consisting of bismuth, copper, indium, a salt thereof, an oxide thereof, and any combination thereof, wherein the additive is plated in a layer on the electroactive material.

2. The metallic electrode of claim 1, where the electroactive material is in the form of a powder, a metallic foil, a mesh, a perforated foil, a patterned foil, a patterned mesh, a wire cloth, a woven wire, a wire mesh, an expanded metal, a twisted metal, a wire, a metallic screen, a hexagonal netting, or any combination thereof.

3. The metallic electrode of claim 1, where the additive is bismuth oxide, bismuth, bismuth hydroxide, bismuth sulfide, bismuth telluride, bismuth selenide, bismuth nitrate, bismuth chloride, copper oxide, copper, copper hydroxide, copper chloride, copper nitrate, indium oxide, indium hydroxide, indium nitrate, or any combination thereof.

4. The metallic electrode of claim 1, wherein the electroactive material comprises zinc.

5. A method of electroplating, the method comprising:
disposing an additive on a metallic electrode, wherein the additive comprises a metal selected from bismuth, copper, indium, a salt thereof, an oxide thereof, or any combination thereof;
pairing the metallic electrode with a counter electrode;
placing the metallic electrode and counter electrode in an electrolyte;
placing a reference electrode in contact with the electrolyte;
using the reference electrode to determine a potential on the metallic electrode potential;
applying the potential on the metallic electrode against the reference electrode; and
reducing the additive to its metallic state in response to applying the potential.

6. The method of claim 5, wherein disposing the additive on the metallic electrode comprises:
forming a paste from the additive; and
pasting the paste onto the metallic electrode.

7. The method of claim 5, wherein the additive in its metallic state is plated in a layer on an electroactive material of the metallic electrode.

8. The method of claim 5, wherein the additive is bismuth oxide, bismuth, bismuth hydroxide, bismuth sulfide, bismuth telluride, bismuth selenide, bismuth nitrate, bismuth chloride, copper oxide, copper, copper hydroxide, copper chloride, copper nitrate, indium oxide, indium hydroxide, indium nitrate, or any combination thereof.

9. The method of claim 5, wherein the counter electrode is nickel oxyhydroxide, manganese dioxide, silver oxide, silver, copper, copper oxide, lithium manganese dioxide, lead, platinum, or any combination thereof.

10. The method of claim 5, wherein the electrolyte is manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or any combination thereof.

11. The method of claim 5, wherein the reference electrode is mercury/mercury oxide (Hg|HgO).

12. The method of claim 5, wherein the step of applying potential on the metallic electrode is constant voltage, constant current, constant load, pulse current, potentiodynamic, or any combination thereof.

13. The method of claim 5, wherein the potential ranges for electroplating in potassium hydroxide, sodium hydroxide and lithium hydroxide against a Hg|HgO is between −2 and −1V.

14. The method of claim 5, wherein electrolyte is selected from a group consisting of potassium hydroxide, sodium hydroxide and lithium hydroxide and a potential between −2V to 0V against a Hg|HgO electrode is applied.

15. The method of claim 5, wherein the electrolyte is selected from a group consisting of potassium hydroxide, sodium hydroxide and lithium hydroxide and a potential between −2V and 0.4V against a Hg|HgO electrode is applied to electroplate.

16. The method of claim 5, wherein the electrolyte is selected from a group consisting of potassium hydroxide, sodium hydroxide and lithium hydroxide and a potential between −1.5V and −1V against a Hg|HgO electrode is applied.

17. A battery comprising:
an anode, wherein the anode comprises an electroactive material and an additive, wherein the electroactive material comprises zinc, aluminum, lithium, magnesium, silver, brass, copper, stainless steel, nickel, selenium, or any combination thereof, wherein the additive comprises a metal selected from bismuth, copper, indium, or a compound of the metal, and wherein the additive is plated in a layer on the electroactive material;
a cathode;
an electrolyte; and
a separator disposed between the anode and the cathode.

18. The battery of claim 17, wherein the cathode is manganese dioxide, copper manganese oxide, hausmannite, manganese oxide, copper intercalated bismuth birnessite, birnessite, todokorite, ramsdellite, pyrolusite, pyrochroite, nickel hydroxide, sintered nickel, nickel oxyhydroxide, potassium permanganate, cobalt oxide, silver oxide, silver, lithium manganese oxide, lithium manganese nickel cobalt oxide, lithium iron phosphate, copper oxide, manganese oxide, lithium vanadium phosphate, vanadium phosphate, vanadium pentoxide, or any combination thereof.

19. The battery of claim 17, wherein the electrolyte is manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or any combination thereof.

20. The battery of claim 17, wherein the separator is lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, CELGARD®, cellophane, or any combination thereof.
